(19) United States
(12) Patent Application Publication
(10) Pub. No.: US 2018/0039890 A1
(43) Pub. Date: Feb. 8, 2018

(54) ADAPTIVE KNOWLEDGE BASE CONSTRUCTION METHOD AND SYSTEM

(71) Applicant: ELECTRONICS AND TELECOMMUNICATIONS RESEARCH INSTITUTE, Daejeon (KR)

(72) Inventors: Mal Hee KIM, Daejeon (KR); Hyun Joong KANG, Jinju (KR); Soon Hyun KWON, Incheon (KR)

(21) Appl. No.: 15/668,646

(22) Filed: Aug. 3, 2017

(30) Foreign Application Priority Data
Aug. 3, 2016 (KR) 10-2016-0098926
Feb. 14, 2017 (KR) 10-2017-0019873

(51) Int. Cl. G06N 5/02; G06F 17/30

(52) U.S. Cl. CPC G06N 5/027; G06N 5/025; G06F 17/30961

(57) ABSTRACT

Provided are an adaptive knowledge base construction system and method. The adaptive knowledge base construction system includes a machine learning engine analyzing a correlation between pieces of data included in a first data set in a process of learning the first data set input thereto, based on machine learning, a rule generator generating a rule based on the machine learning by using an analysis result obtained by analyzing the correlation, and a semantic rule generator generating a semantic rule from the rule based on the machine learning by using a language expressing ontology, and reflecting the generated semantic rule in a knowledge base to extend the knowledge base.

### CROSS-REFERENCE TO RELATED APPLICATIONS

This application claims priority under 35 U.S.C. §119 to Korean Patent Application No. 10-2016-0098926, filed on Aug. 3, 2016 and Korean Patent Application No. 10-2017-0019873, filed on Feb. 14, 2017, the disclosure of which is incorporated herein by reference in its entirety.

### TECHNICAL FIELD

The present invention relates to an adaptive knowledge base construction method and system, and more particularly, to an adaptive knowledge base construction method and system which convert a learned result, generated based on machine learning, into a rule and construct the rule in a knowledge base by using semantic technology.

### BACKGROUND

Recently, research on machine learning and semantic technology is being actively done. The machine learning is technology that performs data-based learning according to an assigned purpose and predicts information necessary for a new environment, based on a learning result.

Generally, a learning method may be categorized into a tree-based analysis method and an association-based analysis method. The tree-based analysis method generates a rule by using node information about a tree constructed based on a learning result, and the association-based analysis method analyzes a pattern of learning data to generate an association rule.

The semantic technology denotes technology where a designer having domain knowledge generates a rule and extends, infers, and reuses knowledge by using the generated rule to construct a knowledge base.

In a case of generating a rule by using the machine learning and generating a result corresponding to a request by using the rule, since there is a generation period, it is unable to reuse a learning result. In the semantic technology, unless a person having domain knowledge changes a rule, a knowledge base is constructed as an extension and inference result, based on rule-based knowledge which is previously generated. In this case, since an actual environment can be dynamically changed by an ambient environment, it is required to adaptively change a rule depending on the ambient environment and construct a knowledge base in which the changed rule is reflected.

### SUMMARY

Accordingly, the present invention provides an adaptive knowledge base construction method and system. In detail, the present invention provides a method and a system, which construct an adaptive knowledge base based on a dynamically changed environment by using machine learning and semantic technology without intervention of a person.

The object of the present invention is not limited to the aforesaid, but other objects not described herein will be clearly understood by those skilled in the art from descriptions below.

In one general aspect, an adaptive knowledge base construction system includes: a machine learning engine analyzing a correlation between pieces of data included in a first data set in a process of learning the first data set input thereto, based on machine learning; a rule generator generating a rule based on the machine learning by using an analysis result obtained by analyzing the correlation; and a semantic rule generator generating a semantic rule from the rule based on the machine learning by using a language expressing ontology, and reflecting the generated semantic rule in a knowledge base to extend the knowledge base.

In another general aspect, an adaptive knowledge base construction system includes: a memory storing a program for providing an adaptive knowledge base construction model; and a processor executing the program, wherein by executing the program, the processor generates a learning model corresponding to a first data set input thereto, outputs a correlation analysis result obtained by analyzing the first data set according to the generated learning model, generates a machine learning rule based on a correlation analysis result obtained by analyzing a correlation between a learned model and a learned algorithm, and generates a semantic rule by using the generated machine learning rule.

In another general aspect, an adaptive knowledge base construction method includes: performing machine learning on an input first data set; generating a machine learning-based rule, based on a learned result; converting the machine learning-based rule into a semantic rule by using a language expressing ontology; and storing the semantic rule to construct a knowledge base.

Other features and aspects will be apparent from the following detailed description, the drawings, and the claims.

### BRIEF DESCRIPTION OF THE DRAWINGS

FIG. 1 is an exemplary diagram for describing a configuration of a computer system where an adaptive knowledge base construction method according to an embodiment of the present invention is implemented.

FIG. 2 is a block diagram of an adaptive knowledge base construction system according to an embodiment of the present invention.

FIG. 3 is a block diagram of an adaptive knowledge base construction system according to another embodiment of the present invention.

FIG. 4 is an exemplary diagram for describing an adaptive knowledge base construction method based on a tree learning model according to some embodiments of the present invention.

FIGS. 5A and 5B are an exemplary diagram for describing an example of generating a rule based on an Apriori algorithm

FIG. 6 is a block diagram of an adaptive knowledge base construction system according to another embodiment of the present invention.

FIG. 7 is a block diagram of an adaptive knowledge base construction system according to another embodiment of the present invention.

FIG. 8 is a flowchart of an adaptive knowledge base construction method according to another embodiment of the present invention.

### DETAILED DESCRIPTION OF EMBODIMENTS

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art. The terms used herein are for the purpose of describing particular embodiments only and are not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Hereinafter, embodiments of the present invention will be described in detail with reference to the accompanying drawings.

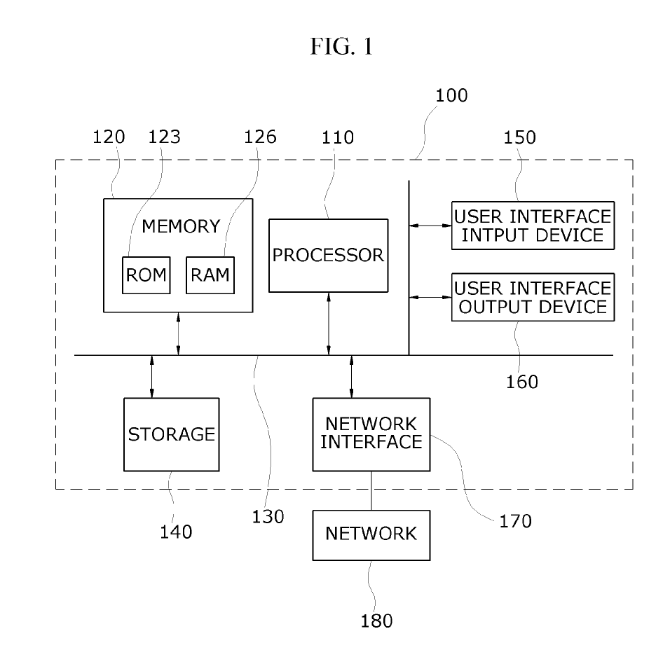

FIG. 1 is an exemplary diagram for describing a configuration of a computer system 100 where an adaptive knowledge base construction method according to an embodiment of the present invention is implemented.

Referring to FIG. 1, an adaptive knowledge base construction method according to an embodiment of the present invention may be implemented in the computer system 100, or may be stored in a recording medium.

The computer system 100 may include at least one processor 110, a memory 120, a data communication bus 130, a storage 140, a user input device 150, and a user output device 160. In addition, the computer system 100 may further include a network interface 170 connected to a network 180. The elements 110, 120, 140, 150, 160, and 170 may perform data communication therebetween through the data communication bus 130.

The processor 110 may be a central processing unit (CPU), or may be a semiconductor device which executes a command stored in the memory 120 and/or the storage 140. The processor 110 may perform a series of processing operations associated with an extension of a knowledge base according to an embodiment of the present invention.

The memory 120 and the storage 140 may each include a volatile or non-volatile storage medium. For example, the memory 120 may include a read-only memory (ROM) 123 and a random access memory (RAM) 126.

When the adaptive knowledge base construction method according to an embodiment of the present invention is performed in a computer device, computer-readable commands may perform an operating method according to an embodiment of the present invention.

The adaptive knowledge base construction method according to an embodiment of the present invention may be implemented with a computer-readable code in a computer-readable recording medium.

Example of the computer-readable recording medium may include all kinds of recording mediums which store data capable of being decoded by a computer system. For example, there may be ROM, RAM, magnetic tape, magnetic disk, flash memory, optical data storage device, etc.

The computer-readable recording medium may be distributed to a computer system connected thereto through a computer communication network and may be stored and executed as a code which is readable through a distributed method. Hereinafter, the computer system may be referred to as an adaptive knowledge base construction system.

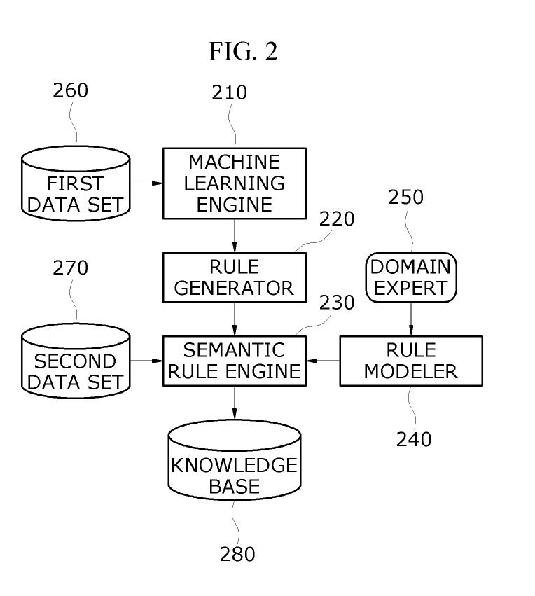

FIG. 2 is a block diagram of an adaptive knowledge base construction system 100 according to an embodiment of the present invention.

Referring to FIG. 2, the adaptive knowledge base construction system 100 according to an embodiment of the present invention may include a machine learning engine 210, a rule generator 220, a semantic rule engine 230, and a knowledge base 280. Also, the adaptive knowledge base construction system 100 may further include a rule modeler 240 of a domain expert. The elements 210, 220, 230, and 280 may each be implemented as an internal logic or an external logic of the processor 110 illustrated in FIG. 1. When each of the elements 210, 220, 230, and 280 is implemented as the external logic of the processor 110, operations of the elements 210, 220, 230, and 280 may be performed by the processor 110.

The rule modeler 240 is for semantic filtering. In a case where the semantic filtering is not used, the rule modeler 240 may be excluded from a design of the adaptive knowledge base construction system 100.

The adaptive knowledge base construction system 100 according to an embodiment of the present invention may operate both a knowledge base construction environment based on semantic modeling and a knowledge base construction environment based on a rule which is learned according to machine learning, or may individually operate each of the knowledge base construction environments. The semantic modeling and the machine learning may be functionally separated from each other, and in consideration of a whole system, may be constructed as a distributed processing system.

The machine learning engine 210 may learn a first data set 260 through the machine learning to generate an optimal learning model. In detail, the machine learning engine 210 may analyze a correlation between pieces of data included in the first data set 260, based on the machine learning and may generate the optimal learning model based on a result of the analysis.

The rule generator 220 may generate a rule corresponding to the analysis result, namely, the correlation between the pieces of data included in the first data set 260. The rule may be generated from an analysis result obtained by analyzing a pattern or the correlation between the pieces of data included in the first data set 260, based on a method such as a learning algorithm based on tree included in the machine learning, an Apriori algorithm, a covariance matrix algorithm, a casual analysis, clustering affinity grouping, dimension reduction, a network analysis (or a link analysis, and/or the like. The rule generator 220 may provide the generated rule to the semantic rule engine 230, or may provide the generated rule to the semantic rule engine 230 in the form of unstructured data.

In FIG. 2, an example where the rule generator 220 is designed outside the machine learning engine 210, but the present embodiment is not limited thereto. In other embodiments, the rule generator 220 may be designed inside the machine learning engine 210.

As described above, the adaptive knowledge base construction system 100 according to an embodiment of the present invention may be constructed as a distributed process system. In this case, the rule generator 220 may be included in a separate server depending on a designing method of the distributed processing system.

The semantic rule engine 230 may convert the rule and the unstructured data, transferred from the rule generator 220, into a semantic rule by using resource description framework (RDF) or ontology Web language (OWL) expressing ontology and may store the semantic rule in the knowledge base 280. Here, the RDF and the OWL may be standard for the semantic Web provided by World Wide Web Consortium (W3C) and may be an ontology (or a knowledge base) technology language. Unlike the RDF, the OWL may be a language which is designed in consideration of knowledge extension in the ontology (or the knowledge base) based on inference.

In this manner, the semantic rule engine 230 may convert the rule, generated from a learning result generated through the machine learning, into the semantic rule and by reflecting the semantic rule in the knowledge base, may construct an adaptive knowledge base based on machine learning technology and semantic technology.

Moreover, the semantic rule engine 230 may determine whether to store the generated semantic rule in the knowledge base 280 or not.

The semantic rule engine 230 may be referred to as an inference engine or an extension engine and may extend the semantic rule. For example, the semantic rule engine 230 may extend the semantic rule previously stored in the knowledge base 280, based on a second data set 270 including a new semantic rule.

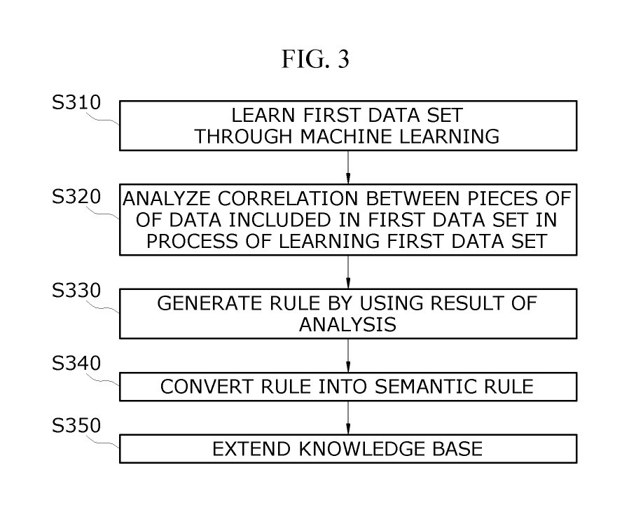

FIG. 3 is a block diagram of an adaptive knowledge base construction system according to another embodiment of the present invention.

Referring to FIG. 3, first, in step S310, the machine learning engine 210 may learn the first data set 260 to generate an optimal learning model.

In step S320, the machine learning engine 210 may analyze a correlation or a pattern between pieces of data included in the first data set 260 in a process of learning the first data set 260.

In step S330, the rule generator 220 may generate a rule by using a result of the analysis.

In step S340, the semantic rule engine 230 may convert the generated rule into a semantic rule. The rule may be converted into the semantic rule by using the RDF or the OWL.

In step S350, a knowledge base may extend by merging the semantic rule and a pre-stored semantic rule.

Hereinafter, a machine learning method according to an embodiment of the present invention will be described in detail.

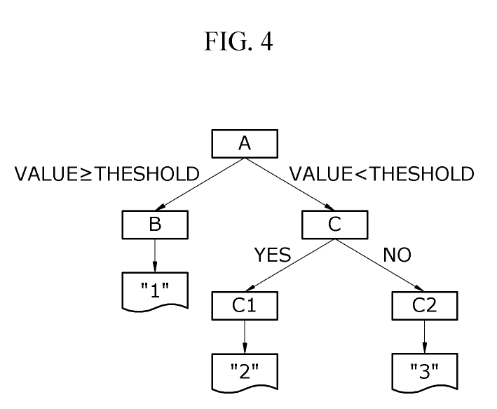

FIG. 4 is an exemplary diagram for describing an adaptive knowledge base construction method based on a tree learning model according to some embodiments of the present invention.

Referring to FIG. 4, A denotes a node representing input data, and each of B, C, C1, and C2 denotes a node representing a learning result obtained through learning based on the machine learning. A tree type data structure corresponding to the input data A and C may be obtained.

In FIG. 4, the tree type data structure is illustrated as representing a simplest tree type data structure, but is not limited thereto. In other embodiments, various trees which are more complicated may be generated, and a control sentence representing a rule for each of the nodes may be generated. For example, when the A is equal to or more than a threshold value, the B representing “1” may be output. When the A is less than the threshold value and an instance value of the C is “yes”, the C1 representing “2” may be output, and when the A is less than the threshold value and the instance value of the C is “no”, the C2 representing “3” may be output.

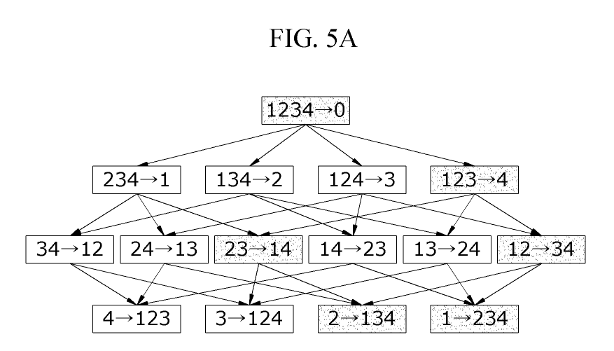

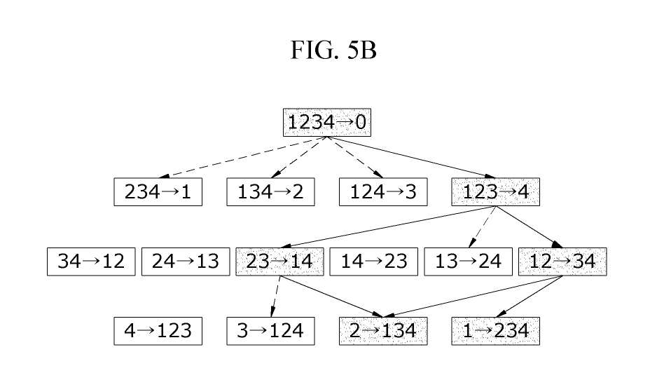

FIG. 5A is an exemplary diagram for describing an example of generating a rule based on an Apriori algorithm which is a type of machine learning method according to another embodiment of the present invention.

In order to held understand description, it is assumed that numbers illustrated in FIG. 5A respectively denote items listed in the following Table 1 and each of A, B, C, D, and E listed in the following Table 2 denotes one transaction, the following Table 2 show items purchased through respective transactions.

TABLE 1

| Item Name | Item ID |
|---|---|
| soy milk | 1 |
| lettuce | 2 |
| diapers | 3 |
| wine | 4 |
| chard | 5 |
| orange juice | 6 |

TABLE 2

| Transaction | | |
|---|---|---|
| ID | Item List | Item ID List |
| A | Soy milk, lettuce | 1, 2 |
| B | Lettuce, diapers | 2, 3 |
| C | Soy milk, wine | 1, 4 |
| D | Lettuce, soy milk, diapers, wine | 2, 1, 3, 4 |
| E | Lettuce, soy milk, diapers | 2, 1, 3 |

A semantic Web of FIG. 5A may be generated with reference to Table 2. The generated semantic Web may be regularized based on a semantic rule.

For example, through an analysis of a lowermost box, it can be seen that a total of four transaction IDs include 1, a total of four transaction IDs include 2, a total of four transaction IDs include 3, and a total of three transaction IDs include 4. These are arranged in the following Table 3.

TABLE 3

| Item Set | Approval Rating |
|---|---|
| {1} | 4 |
| {2} | 4 |
| {3} | 3 |
| {4} | 2 |

In this case, when a minimum approval rating is set to 4, {1} and {2} may be classified into a frequent item set, and {3} and {4} may be classified into an infrequent item set. In FIG. 5A, the frequent item set is inverted and illustrated.

Likewise, an approval rating may be calculated from an item set where the number of elements is two. This is shown in the following Table 4.

TABLE 4

| Item Set | Approval Rating |
|---|---|
| {1, 2} | 3 |
| {1, 3} | 2 |
| {1, 4} | 2 |
| {2, 3} | 3 |
| {2, 4} | 1 |
| {3, 4} | 1 |

In this case, when a minimum approval rating is set to 3, {1,2} and {2,3} may be classified into a frequent item set, and {1,3}, {1,4}, {2,4}, and {3,4} may be classified into an infrequent item set. In FIG. 5A, the frequent item set is inverted and illustrated.

Likewise, an approval rating may be calculated from an item set where the number of elements is three. This is shown in the following Table 5.

TABLE 5

| Item Set | Approval Rating |
|---|---|
| {1, 2, 3} | 2 |
| {1, 2, 4} | 1 |
| {1, 3, 4} | 1 |
| {2, 3, 4} | 1 |

In this case, when a minimum approval rating is set to 2, {1,2,3} may be classified into a frequent item set, and {1,3}, {1,2,4}, {1,3,4}, and {2,3,4} may be classified into an infrequent item set. In FIG. 5A, the frequent item set is inverted and illustrated.

Likewise, in a case where an approval rating is calculated from an item set where the number of elements is four, {1,2,3,4} has an approval rating of 1, and thus, when a minimum approval rating is 1, this corresponds to a frequency item set. On the other hand, when the minimum approval rating is 2, this corresponds to an infrequency item set. In FIG. 5A, a case where a minimum approval rating is 1 is provided.

The Apriori algorithm may be a machine learning method that prunes an infrequent item and increases a calculation speed.

FIG. 5B is an exemplary diagram for describing an example of generating a rule based on an Apriori algorithm according to another embodiment of the present invention.

FIG. 5B is a diagram illustrating a result obtained by pruning a node less than a minimum approval rating in FIG. 5A.

In all trees, the number of operations exponentially increases based on the number of items. In this case, a computer cannot satisfy a calculation speed. In a case where a node equal to or less than a minimum approval rating is pruned and an arithmetic operation is continuously performed on only a node equal to or more than the minimum approval rating, a semantic rule between nodes may be generated through a small number of operations. In FIG. 5B, a dotted-line arrow indicates a pruned node.

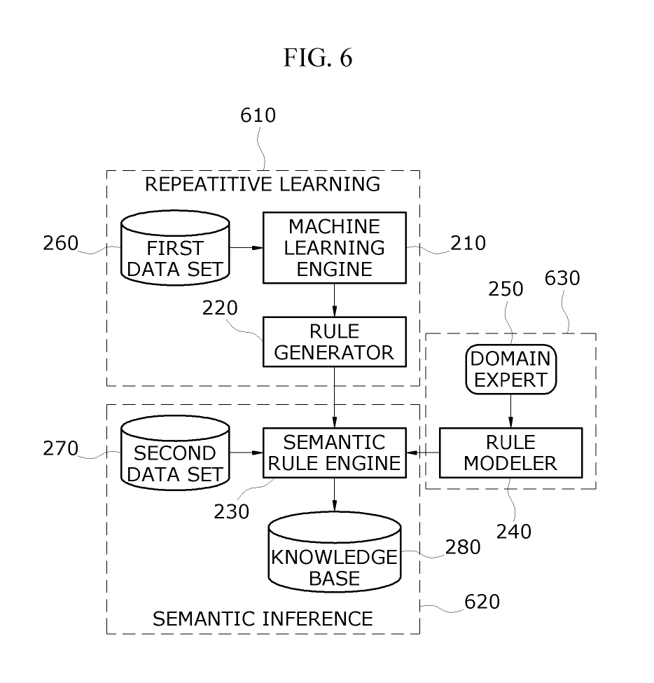

FIG. 6 is a block diagram of an adaptive knowledge base construction system according to another embodiment of the present invention.

Referring to FIG. 6, the adaptive knowledge base construction system according to another embodiment of the present invention may include a rule generation server 610, a semantic rule generation server 620, and a rule modeler server 630.

The rule generation server 610 may include a machine learning engine 210 and a rule generator 220. In order to avoid repetitive descriptions, the descriptions of FIG. 2 may be applied to the machine learning engine 210 and the rule generator 220.

The rule generation server 610 may repetitively learn a first data set 260 by using the machine learning to generate a rule corresponding to a correlation between pieces of data which are dynamically changed.

The semantic rule generation server 620 may include a semantic rule engine 230 and a storage 280 which stores a knowledge base 280. In order to avoid repetitive descriptions, the descriptions of FIG. 2 may be applied to the semantic rule engine 230 and the storage 280.

The semantic rule generation server 620 may generate a semantic rule from a machine learning-based rule provided from the rule generation server 610 and may store the semantic rule in the knowledge base 280 to extend the knowledge base 280.

Moreover, the semantic rule generation server 620 may perform semantic inference on a second data set 270 to extend the knowledge base 280.

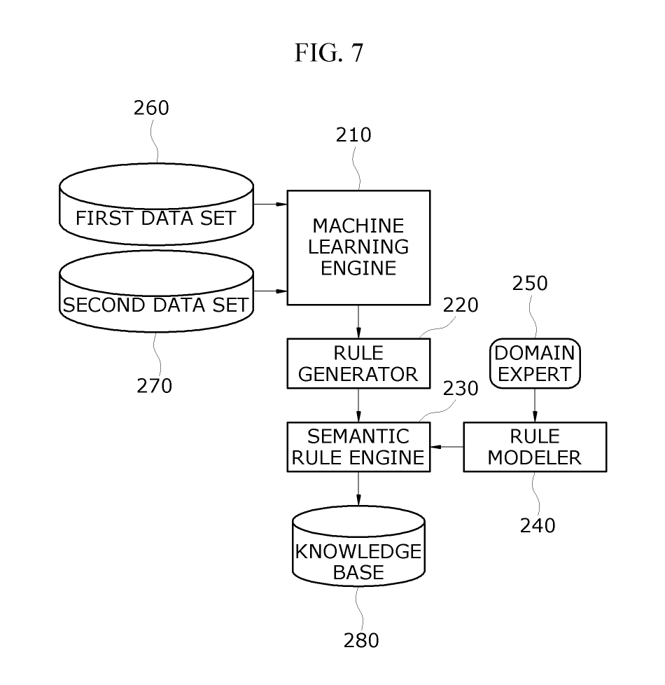

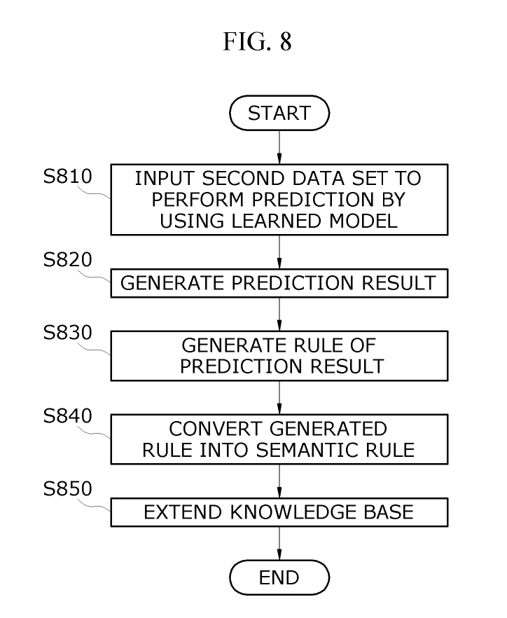

Moreover, the semantic rule generation server 620 may perform semantic inference on the second data set 270 by using the semantic rule generated from the machine learning-based rule provided from the rule generation server 610 to extend the knowledge base 280. This will be described below with reference to FIGS. 7 and 8.

The semantic rule engine of the semantic rule generation server 620 may correct a semantic rule by using a rule model input from a rule modeler 240 and may change a method of converting the machine learning-based rule into the semantic rule.

The rule modeler server 630 may include the rule modeler 240 that transmits a rule model, input by a domain expert, to the semantic rule engine 230.

Although not shown, the rule modeler 240 may provide a user interface (UI) to the semantic rule engine 230 in order to enable the domain expert to input the rule model.

Moreover, the rule modeler 240 may provide the semantic rule engine 230 with a UI that connects a machine learning rule and a semantic rule.

Moreover, the rule modeler 240 may view a connection relationship between the semantic rule and the machine learning-based rule generated by the machine learning engine 210 before the connection relation is stored in the knowledge base 280, and may provide a correctable UI to the semantic rule engine 230.

FIG. 7 is a block diagram of an adaptive knowledge base construction system according to another embodiment of the present invention.

Referring to FIG. 7, the adaptive knowledge base construction system according to another embodiment of the present invention has a difference with the system described above with reference to FIG. 6 in that a second data set 270 is input to a machine learning engine 210 instead of a semantic rule engine 230.

It is possible for a semantic rule engine to be designed in a machine learning engine. However, since a machine learning process needs a long learning time, the new second data set 270 and a first data set 260 may all be input to the machine learning engine 210 in order to shorten the long learning time, and by processing the first data set 260 and the new second data set 270 through a one-time machine learning process, computer resources are efficiently used.

The adaptive knowledge base construction system according to an embodiment of the present invention may be constructed as a distributed processing system, and when a machine learning engine is constructed as a parallel type system in a plurality of servers and a semantic rule engine is installed in a small number of servers, a method of inputting a second data set to the machine learning engine may efficiently distribute resources.

The adaptive knowledge base construction system according to another embodiment of the present invention may include: a machine learning engine that generates a learning model corresponding to a first data set, analyzes a pattern or a correlation between pieces of data included in the first data set by using the generated learning model, generates a semantic inference model corresponding to a second data set, and performs inference by using the generated semantic inference model and the second data set to generate a prediction result; a rule generator that generates a machine learning rule from a learned model result obtained through analysis by the machine learning engine and generates a machine learning rule from the prediction result; and a semantic rule engine that converts the machine learning rule, transferred from the rule generator, into a semantic rule and stores the semantic rule to construct a knowledge base.

The adaptive knowledge base construction system may further include a rule modeler that changes, by a domain expert, a semantic rule generation method.

Depending on the case, a machine learning rule as well as a semantic rule may extend. However, since a machine learning-based rule has a significant characteristic, it is required to adaptively change the machine learning-based rule in an environment where an actual environment is dynamically changed, but changing of the machine learning engine is not efficient.

The rule modeler 240 may change a method of converting a machine learning rule into a semantic rule, instead of extending a machine learning-based rule, thereby enabling a user to select an appropriate conversion method in a dynamically changed environment.

A domain expert is not a person who knows a structure of the adaptive knowledge base construction system according to an embodiment of the present invention, but is a person who has sufficient knowledge about information about a semantic rule. Therefore, instead of immediately storing a generated semantic rule in a knowledge base, the domain expert may determine whether to use the generated semantic rule, and based on the determination, the rule modeler 240 may operate.

The rule modeler 240 may determine a method of converting a machine learning rule into a semantic rule through a separate learning process and may transfer the determined conversion method to the semantic rule engine 230, and the semantic rule engine 230 may construct a knowledge base by using the conversion method provided from the rule modeler 240.

The semantic rule engine 230 may construct the knowledge base, based on the machine learning-based rule provided from the rule generator 220, the second data set, and the rule model provided from the rule modeler 240. Such a process may not be immediately performed but may be performed at appropriate periods.

The semantic rule engine 230 may have a characteristic where a knowledge base is differently constructed based on an input order in which the first data set is input, an input order in which the second data set is input, and an input order in which the rule model is input.

However, when input data is actually changed with time, an analysis of the data is generally changed. For example, when a home boiler operates in an Internet of things (IoT) environment, machine learning content may be changed according to a time when the boiler operates. That is, the adaptive knowledge base construction system according to an embodiment of the present invention has a more robust characteristic in a dynamically changed environment.

FIG. 8 is a flowchart of an adaptive knowledge base construction method according to another embodiment of the present invention.

Referring to FIG. 8, the adaptive knowledge base construction method may include: an operation (S810) of generating a semantic inference model corresponding to a second data set; an operation (S820) of analyzing the semantic inference model to generate a prediction result for generation of a rule; an operation (S830) of generating a machine learning rule from the prediction result; an operation (S840) of regularly converting the machine learning rule into a semantic rule; and an operation (S850) of storing the semantic rule to extend a knowledge base.

Unlike the embodiment of FIG. 3, in the present embodiment, a knowledge base which is analyzed by using a first data set as input data may be based on a construction environment.

There is a difference in that in such an environment, a new second data set is input to a machine learning engine instead of a semantic rule engine, and semantic inference is performed.

When the new second data set is directly input to the semantic rule engine, the semantic inference may be performed the constructed knowledge base, but since the machine learning engine needs a high-specification server generally, a computing power of the machine learning engine is better.

In a case of inputting the second data set to the machine learning engine, inference may be quickly performed on the second data set by using the high-specification server.

Data which is previously used may be again input to the semantic rule engine and may be checked by using the constructed knowledge base, and the knowledge base may extend.

As described above, according to the embodiments of the present invention, a knowledge base may be constructed by combining machine learning technology and semantic technology, and thus, intervention of a person is prevented, thereby obtaining an optimal analysis and high efficiency.

Moreover, the present invention may be applied to IoT technology, an analysis associated with big data technology, and the intelligent service industry field related to a context-aware service, and may be used as a platform in the analysis technology field using machine learning.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An adaptive knowledge base construction system comprising:
a machine learning engine analyzing a correlation between pieces of data included in a first data set in a process of learning the first data set input thereto, based on machine learning;
a rule generator generating a rule based on the machine learning by using an analysis result obtained by analyzing the correlation; and
a semantic rule generator generating a semantic rule from the rule based on the machine learning by using a language expressing ontology, and reflecting the generated semantic rule in a knowledge base to extend the knowledge base.

2. The adaptive knowledge base construction system of claim 1, wherein the rule generator generates the rule by using one of a tree-based rule generation algorithm and an Apriori algorithm.

3. The adaptive knowledge base construction system of claim 1, further comprising: a rule modeler providing the semantic rule generator with a rule model for changing a method of generating the semantic rule.

4. The adaptive knowledge base construction system of claim 3, wherein the semantic rule generator performs semantic filtering on the rule by using the rule model provided from the rule modeler.

5. An adaptive knowledge base construction system comprising:
a memory storing a program for providing an adaptive knowledge base construction model; and
a processor executing the program,
wherein by executing the program, the processor generates a learning model corresponding to a first data set input thereto, outputs a correlation analysis result obtained by analyzing the first data set according to the generated learning model, generates a machine learning rule based on a correlation analysis result obtained by analyzing a correlation between a learned model and a learned algorithm, and generates a semantic rule by using the generated machine learning rule.

6. The adaptive knowledge base construction system of claim 5, wherein the processor converts the machine learning rule into a semantic rule by using a language expressing one ontology of resource description framework (RDF) and ontology Web language (OWL).

7. The adaptive knowledge base construction system of claim 5, wherein the processor generates a learning model and an inference model corresponding to the first data set and a newly input second data set.

8. The adaptive knowledge base construction system of claim 5, wherein the processor generates a semantic rule by using a rule model input by a domain expert.

9. An adaptive knowledge base construction method comprising:
performing machine learning on an input first data set;
generating a machine learning-based rule, based on a learned result;
converting the machine learning-based rule into a semantic rule by using a language expressing ontology; and
storing the semantic rule to construct a knowledge base.

10. The adaptive knowledge base construction method of claim 9, wherein the language expressing the ontology is one of resource description framework (RDF) and ontology Web language (OWL).

11. The adaptive knowledge base construction method of claim 9, wherein the generating of the rule comprises generating the rule by using one of a tree-based rule generation algorithm and an Apriori algorithm.
